(19) United States
(12) Patent Application Publication
(10) Pub. No.: US 2020/0176726 A1
(43) Pub. Date: Jun. 4, 2020

(54) REPEATEDLY BENDABLE FLEXIBLE BATTERY

(71) Applicants: Ching Chung POON, Kowloon (HK); Man Yung David YEUNG, Kowloon (HK)

(72) Inventors: Ching Chung POON, Kowloon (HK); Man Yung David YEUNG, Kowloon (HK)

(21) Appl. No.: 16/701,661

(22) Filed: Dec. 3, 2019

Related U.S. Application Data
(60) Provisional application No. 62/774,433, filed on Dec. 3, 2018.

(51) Int. Cl. H01M 2/02; H01M 2/08

(52) U.S. Cl. CPC H01M 2/0275; H01M 2/08; H01M 2/0287

(57) ABSTRACT

The invention provides a flexible battery comprising a flexible battery unit, at least one protective layer formed by a flexible material, and an enclosure defining an interior space. The at least one protective layer is formed on one side of the battery unit to define a stack structure which is placed hermetically inside the interior space of the enclosure. The at least one protective layer is configured to give a uniform curvature in a bending direction along which the battery is bent. The at least one protective layer is arranged in such a way to shield the battery unit from impacts of the enclosure caused by deformation and/or bending of the battery.

### CROSS REFERENCE TO RELATED PATENT APPLICATION

This application claims priority to and benefit of U.S. Provisional Patent Application No. 62/774,433 entitled “Repeatedly Bendable Flexible Battery Structure” filed on Dec. 3, 2018 which is herein incorporated by reference in their entirety for all purposes.

### FIELD OF THE INVENTION

This invention relates generally to flexible battery structures, and particularly to structures of flexible and repeatedly bendable batteries which can provide extra mechanical strength and make the batteries durable and reliable.

### BACKGROUND OF THE INVENTION

Flexible battery has increasing demand with the emergence of the market of wearable electronics. Wearable devices such as smart bands or smart watch suffer from insufficient battery life. Comparing to conventional wristwatches running on electric power, smart watch is considerably more power-hungry in order to support the sophisticated sensors, software, and especially the display. Meantime, market demands wearable devices having more processing power and less volume. State of art smart watches typically runs on internal battery for from one day to a couple of days between recharges, which is undesirable for consumers.

Making use of flexible strap volume to house additional battery is an effective solution to increase total power storage for wrist electronic device. There are few solutions available in the market but no single solution has yet fulfilled market expectation for flexibility, capacity, output power, reliability and durability.

Flexible or bendable electrode (anode and cathode) materials are known for flat and thin batteries. The electrodes and electrolytes are enclosed by an outer housing, such as metal cylinders for common dry cells. Besides metal shells, use of polymer-metal-polymer laminate foils are also common in battery packaging. Such foil packaging is water vapor proof and flexible. In prior art flexible battery structures, the laminate foil layer is in direct contact with the electrode so as to hermetically seal the inner cavity of battery from outer air and moisture.

When a battery using a foil package is bent, the inner side becomes shorter than the outer side, and wrinkles or sharp corners are always created on the inner side. The thicker the battery is and the more it is bent, the more wrinkles are created. When the battery is repeatedly bent, these wrinkles or sharp corners are repeatedly pushed towards the electrodes. Such kind of impacts result in weak points along the battery which impair the mechanical strength of the electrodes, and would eventually break them. A schematic diagram of the bending of a flexible battery and wrinkles thus formed is shown in FIG. 1.

Therefore, there is a need for a flexible battery which provides extra mechanical strength and which is not vulnerable to bending of the battery.

### SUMMARY OF THE INVENTION

The present invention is provided to address the above problem associated with the prior art flexible batteries, and aims to provide a flexible battery structure which protects electrodes from damages caused by the wrinkles or sharp corners formed on the foil package when the battery is repeatedly bent over thousands of cycles. In addition.

Another object of the invention is to provide a flexible battery which can provide extra mechanical strength and protect the battery from other mechanical abuses.

The above objects are satisfied by a flexible battery of the present invention, comprising a flexible battery unit comprising in the following order
(i). cathode substrate,
(ii). cathode active material layer,
(iii). electrolyte layer,
(iv). anode active material layer,
(v). anode substrate,
at least one protective layer formed by a flexible material, and
an enclosure defining an interior space,

wherein the at least one protective layer is formed on one side of the battery unit to define a stack structure which is placed hermetically inside the interior space of the enclosure, and

the at least one protective layer is arranged in such a way to shield the battery unit from impacts of the enclosure caused by deformation and/or bending of the battery.

In one preferable embodiment of the invention, the flexible battery of the present invention comprises:
a first protective layer formed by a flexible material, and
a second protective layer formed by a flexible material,

wherein the battery unit is sandwiched between the first and second protective layers to define a stack structure which is placed hermetically inside the interior space of the enclosure, and
the first and second protective layers are arranged in such a way to shield the battery unit from the impacts of the enclosures caused by the deformation and/or the bending of the battery.

Preferably, the at least one protective layer may be configured to give a uniform curvature in a bending direction along which the battery is bent, and

In the flexible battery of the present invention, at least one protective layer is provided on the stack structure of the flexible battery, in order to protect the cathode substrate and/or the anode substrate from being damaged by the wrinkles or sharp corners formed in the enclosure when the flexible battery is bent. The protective layer is configured to have a width narrower than the width of the interior space, so as to accommodate the deformation of the battery when the battery is bent.

Advantageously, the first and second protective layers can be provided on both sides of the battery unit in the flexible battery. In case the battery is only intended to be bend to one side, only one protective layer can be provided on the inner side of the bending, i.e. the side with the smaller radius of curvature. Such structure is possible to reduce the thickness of the battery while maintaining the flexibility and durability of the structure.

According to the present invention, the protective layer may be made of a metal sheet or a polymer sheet with good bendability and resilience. For example, the protective layer may be made of a material selected from the group consisting of stainless steel, aluminum, copper, polyethylene, polyvinyl chloride, polyimide, Teflon and silicone.

If the protective layer is made of a conductive material, the flexible battery may further comprise an extra insulation layer between the protective layer and the cathode/anode substrate. In other words, the flexible battery of the present invention further comprises a first insulation layer between the first protective layer and the cathode substrate; and/or a second insulation layer between the second protective layer and the anode substrate.

In one specific embodiment of the present invention, the enclosure is formed by a first package layer and a second package layer which are sealed along their peripheral edges.

Preferably, the first and second package layers are made of a laminate comprising an aluminum foil having a top surface and a bottom surface, a top polymer material layer laminated onto the top surface of the aluminum foil, and a bottom polymer material layer laminated onto the bottom surface of the aluminum foil.

In the flexible battery of the present invention, the battery unit further comprises two electrode leads in respective electrical connection to the cathode substrate and the anode substrate, and the two electrode leads protrude respectively beyond two lengthwise end portions of the first package layer and the second package layer.

Preferably, the two electrode leads are hermetically glued onto the two end portions of the first and second package layers in water resistant manner.

The flexible battery unit can be any type of battery cells with bendable electrodes having a suitable output voltage and energy density. For example, the battery unit may be a lithium-ion battery, in which the cathode substrate can be an aluminum foil; the cathode active material layer may be a compound of lithium such as LiCoO₂; the electrolyte layer may be a separator substrate soaked with electrolyte; the anode active material layer may be a graphite or graphene layer; and the anode substrate may be a copper foil.

Preferably, the cathode active material layer may be coated on the cathode substrate; and/or the anode active material layer may be coated on the anode substrate.

It would be within the ability of a person skilled in the art that one or more electrode layers are possible for the invention in accordance with the actual needs.

In order to provide a flexible battery with higher electrical capacity, the battery unit may be configured to further comprise a first set of layers (C) arranged to follow the anode substrate (7), the first set of layers (C) comprising in the following order:
(i). second anode active material layer;
(ii). second electrolyte layer;
(iii). second cathode active material layer;
(iv). second cathode substrate.

Furthermore, the battery unit may be configured to further comprise a second set of layers (A) arranged to follow the first set of layers (C), the second set of layers (A) comprising in the following order
(i). third cathode active material layer;
(ii). third electrolyte layer;
(iii). third anode active material layer;
(iv). third anode substrate.

In addition, it would be appreciated that one or more sets of layers (C) and layers (A) are included in alternate manner in the battery unit.

### BRIEF DESCRIPTION OF DRAWINGS

FIG. 1 is a schematic diagram of a prior art flexible battery, showing the bending of the flexible battery with wrinkles and corners thus formed.

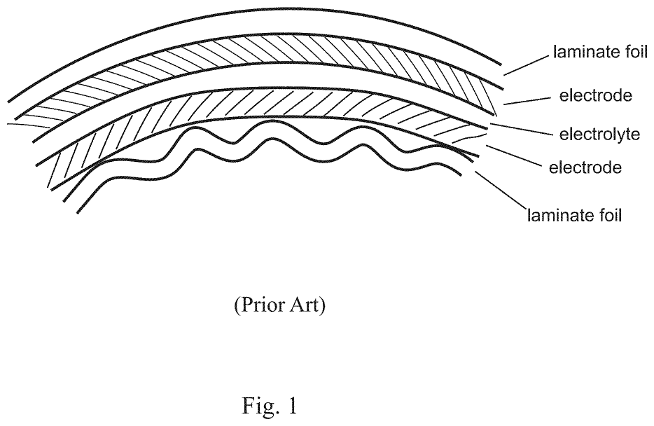

FIG. 2 is a schematic diagram in cross section of a flexible battery according to an embodiment of the present invention.

### DETAILED DESCRIPTION OF EMBODIMENTS

The present invention together with the preferred embodiments for carrying out the invention will be described in detail in the following with reference to the drawings.

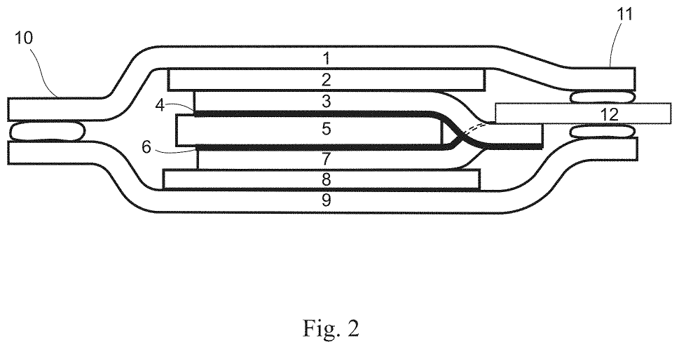

FIG. 2 schematically provides in cross-section an exemplary flexible battery of the invention, comprising a flexible and bendable battery unit of multi-layered structure formed by cathode substrate 3, cathode active material layer 4, electrolyte layer 5, anode active material layer 6, and anode substrate 7. The battery further comprises a first protective layer 2 and a second protective layer 8 between which the batter unit is arranged, and a first package layer 1 and a second package layer 9 which form together to encapsulate the sandwich structure formed by the first and second protective layers 2, 8 and the battery unit. As illustrated, the flexible battery comprises in the following order:
(i). first package layer 1;
(ii). first protective layer 2;
(ii). cathode substrate 3;
(iv). cathode active material layer 4;
(v). electrolyte layer 5;
(vi). anode active material layer 6;
(vii). anode substrate 7;
(viii). second protective layer 8; and
(ix). second package layer 9.

The flexible battery unit comprising the multiple layers 3-7 is any type of battery cells with bendable electrodes having a suitable output voltage and energy density. For example, the battery unit is provided as a lithium-ion battery in which the cathode substrate 3 is an aluminum foil; the cathode active material layer 4 is a compound of lithium such as LiCoO₂; the electrolyte layer 5 is a separator substrate soaked with electrolyte; the anode active material layer 6 is graphite or some graphene layers; and the anode substrate 7 is a copper foil.

In preferred embodiment of the present invention, the cathode active material layer 4 is coated on the cathode substrate 3. Similarly, the anode active material layer 6 is coated on the anode substrate 7.

In this embodiment, each of the first package layer 1 and the second package layer 9 comprises a laminate comprising an aluminum foil, a top polymer material layer and a bottom polymer material layer with the aluminum foil arranged therebetween.

Specifically, the top polymer material layer is laminated onto a top surface of the aluminum foil, and the bottom polymer material layer is laminated onto a bottom surface of the aluminum foil. The top and bottom polymer materials may be selected from a same polymer material or different polymer materials which are selected from polypropylene or nylon.

As shown in FIG. 2, the layers 2-8 form together a stack structure, and the package layers 1 and 9 are larger in lengthwise dimensions to form an enclosure and to define an interior space to encapsulate the stack structure formed by the multiple layers 2-8.

The peripheral edges of the first and second package layers 1 and 9 are hermetically sealed by standard welding techniques, such as heat-sealing using heat activated adhesive materials. The enclosure defines two lengthwise end portions 10, 11. The battery further comprises two electrode leads each in electrical connection to the cathode and anode substrates. The two electrode leads protrude beyond the same sealed end portion 11 of the enclosure formed by the package layers 1 and 9 for connection with the electronics of the wearable devices such as smart bands or smart watch, and are hermetically glued onto the first and second package layers at the end portion 11 in water resistant manner. Only one electrode lead 12 in connection to the cathode substrate 3 is visible in FIG. 2, as the other electrode lead is at the same level and behind the shown electrode lead viewed in this figure.

The first protective layer 2 and the second protective layer 8 are the essential feature of the invention, which may be made of a metal sheet or polymer sheet with good bendability and resilience, such as stainless steel, aluminum, copper, polyethylene, polyvinyl chloride, polyimide, Teflon, silicone, etc. Protective layers 2 and 8 can be made from the same or different materials. The first protective layer 2 and the second protective layer 8 are arranged between the battery and the respective sides of the multi-layered battery unit to prevent the whole battery unit from being in contact with any internal or external wrinkles and sharp corners formed on the first and second package layers 1 and 9 as a result of the bending of the battery. The first and second protective layers 2, 8 can withstand the impacts or pressures originating from the wrinkles and the sharp corners, thereby eliminating any possible weak points of the battery in the lengthwise direction and at the same avoiding the sharp angles that might act on the electrodes of the battery unit. In essence, the first and second protective layers 2, 8 function as an effective shield against any external or internal sharps corners or wrinkles arising from the deformation or bending of the first and second package layers 1, 9 when the battery is bent.

Moreover, the first and second protective layers 2, 8 may ensure a uniform curvature to the battery in the bending direction when it is bent. This further smoothes out the bending curvature and makes the battery reliably bendable.

If the first and second protective layers 2, 8 is made of a conductive material (e.g. stainless steel), there will be an extra insulation layer between the protective layer and the layer of the battery unit in contact with the protective layer, i.e. the cathode/anode substrate. In this embodiment, the insulation layers may be provided between the layers 2 and 3, and/or between the layers 8 and 7. The insulation layer can be a coating, a lamination or an additional layer providing the electrical insulation. Moreover, as shown in FIG. 2, the protective layer is slightly shorter than the interior space of the enclosure in the lengthwise direction so as to accommodate the deformation of the metal sheet (i.e. the protective layer) and the wrinkles formed on the package layers.

It would be appreciated that the first protective layer 2 or the second protective layer 8 can be removed if the battery is not intended to be bent with the first package layer 1 or the second package layer 9 as the inner side of the bending. In order to increase the electrical capacity of the flexible battery of the invention, one or more additional sets of layers that generate one or more battery units can be added to the flexible battery unit discussed above.

In some instances, a first set of layers called Set C of layers can be arranged to follow the anode substrate 7 shown in FIG. 2. The first set of layers C comprises in the following order
(i). second anode active material layer;
(ii). second electrolyte layer;
(iii). second cathode active material layer; and
(iv). second cathode substrate.

In some instances, a second set of layers called Set A of layers can be arranged to follow the first set of layers (C). The second set of layers (A) comprises in the following order:
(i). third cathode active material layer;
(ii). third electrolyte layer;
(iii). third anode active material layer;
(iv). third anode substrate.

Additionally, another first set of layers C can be arranged to follow the second set of layers A, and subsequently another set of layers A can be arranged to follow said another set of layers C to generate one or more additional battery units. It is advantageous that two or more first sets of layers C alternates with two or more second sets of layers A to form a battery unit of large capacity placed in the enclosure.

There is no restriction to the number of the first and second sets of layers A, C. For example, the flexible battery may be configured to comprise a structure of layers 1-2-3-4-5-6-7-C-A-C-8-9 or 1-2-3-4-5-6-7-C-A-C-A-8-9 in respective orders. Such a structure increases the battery capacity by introducing additional electrode and electrolyte layers.

It is understood that all the anode layers with their respective active material layers and the cathode layers with their respective active material layers can be interchanged at the same time. Specifically, besides the original stack structure of layers 1-2-3-4-5-6-7-8-9 or layers 1-2-3-4-5-6-7-C-A-8-9, after interchanging the cathodes and anodes, the stack structure of the flexible battery can be formed by layers 1-2-7-6-5-4-3-8-9 or 1-2-7-6-5-4-3-A-C-8-9, respectively.

In summary, the invention provides a flexible battery comprising additional protective layers formed with the materials of metal or polymer sheet. The flexible battery according to the present invention is found to exhibit the advantages of improved flexibility, capacity and output power, increased mechanical strength, as well as remarkable reliability and durability desirable for use in wearable devices.

Without wishing to be bound by theory, the flexible battery of the present invention can be used in applications requiring bending or folding actions other than wearable devices, for example, in devices having flexible displays, such as foldable mobile phones.

The above described are preferred embodiments of the flexible battery of the present invention. It is understood that the present invention is not limited to the above embodiments and any appropriate modifications can be adopted within the scope of the present invention as long as they can achieve the effects of the present invention.

What is claimed is:

1. A flexible battery, comprising
a flexible battery unit comprising in the following order:
(i). cathode substrate (3),
(ii). cathode active material layer (4),
(iii). electrolyte layer (5),
(iv). anode active material layer (6),
(v). anode substrate (7),
at least one protective layer formed by a flexible material, and
an enclosure defining an interior space,
wherein the at least one protective layer is formed on one side of the battery unit to define a stack structure which is placed hermetically inside the interior space of the enclosure, and
the at least one protective layer is arranged in such a way to shield the battery unit from impacts of the enclosure caused by deformation and/or bending of the battery.

2. The flexible battery according to claim 1, comprising
a first protective layer (2) formed by a flexible material, and
a second protective layer (8) formed by a flexible material,
wherein the battery unit is sandwiched between the first and second protective layers to define a stack structure which is placed hermetically inside the interior space of the enclosure,
the first and second protective layers are arranged in such a way to shield the battery unit from the impacts of the enclosures caused by the deformation and/or the bending of the battery.

3. The flexible battery according to claim 2, wherein the first protective layer and the second protective layer are made of a metal sheet or a polymer sheet.

4. The flexible battery according to claim 3, wherein the first protective layer and the second protective layer are made of a material selected from the group consisting of stainless steel, aluminum, copper, polyethylene, polyvinyl chloride, polyimide, Teflon and silicone.

5. The flexible battery according to claim 2, further comprising
a first insulation layer between the first protective layer (2) and the cathode substrate (3); and/or
a second insulation layer between the second protective layer (8) and the anode substrate (7).

6. The flexible battery according to claim 1, wherein the enclosure is formed by a first package layer (1) and a second package layer (9) which are sealed along their peripheral edges.

7. The flexible battery according to claim 6, wherein the first and second package layers are made of a laminate comprising an aluminum foil having a top surface and a bottom surface, a top polymer material layer laminated onto the top surface of the aluminum foil, and a bottom polymer material layer laminated onto the bottom surface of the aluminum foil.

8. The flexible battery according to claim 6, wherein
the battery unit further comprises two electrode leads (12) in respective electrical connection to the cathode substrate and the anode substrate, and
the two electrode leads protrude respectively beyond two lengthwise end portions (10, 11) of the first package layer and the second package layer.

9. The flexible battery according to claim 8, wherein
the two electrode leads are hermetically glued onto the two end portions (10, 11) of the first and second package layers in water resistant manner.

10. The flexible battery according to claim 1, wherein
the cathode substrate is an aluminum foil;
the cathode active material layer is a compound of lithium;
the electrolyte layer is a separator substrate soaked with electrolyte;
the anode active material layer is a graphite or graphene layer; and
the anode substrate is a copper foil.

11. The flexible battery according to claim 1, wherein
the cathode active material layer is coated on the cathode substrate; and/or
the anode active material layer is coated on the anode substrate.

12. The flexible battery according to claim 1, wherein the battery unit further comprises a first set of layers (C) arranged to follow the anode substrate (7), the first set of layers (C) comprising in the following order:
(i). second anode active material layer;
(ii). second electrolyte layer;
(iii). second cathode active material layer;
(iv). second cathode substrate.

13. The flexible battery according to claim 12, wherein the battery unit further comprises a second set of layers (A) arranged to follow the first set of layers (C), the second set of layers (A) comprising in the following order:
(i). third cathode active material layer;
(ii). third electrolyte layer;
(iii). third anode active material layer;
(iv). third anode substrate.

14. The flexible battery according to claim 13, wherein the battery unit further comprises one or more sets of layers (C) and layers (A) In alternate order.

15. The flexible battery according to claim 1, wherein the at least one protective layer is configured to give a uniform curvature in a bending direction along which the battery is bent.

16. The flexible battery according to claim 2, wherein the first and second protective layers are configured to respectively give a uniform curvature in a bending direction along which the battery is bent.

17. The flexible battery according to claim 7, wherein the top polymer material layer and the bottom polymer material layer are selected from polypropylene or nylon.
